(19) United States
(12) Patent Application Publication
(10) Pub. No.: US 2025/0365049 A1
(43) Pub. Date: Nov. 27, 2025

(54) COHERENT JOINT TRANSMISSIONS WITH TRANSMISSION RECEPTION POINT (TRP) LEVEL POWER RESTRICTIONS

(71) Applicant: QUALCOMM Incorporated, San Diego, CA (US)

(72) Inventors: Jing DAI, Beijing (CN); Lei XIAO, San Jose, CA (US); Chenxi HAO, Beijing (CN); Faris RASSAM, El Cajon, CA (US); Liangming WU, Beijing (CN); Wei XI, Beijing (CN)

(21) Appl. No.: 18/874,117

(22) PCT Filed: Aug. 12, 2022
(86) PCT No.: PCT/CN2022/112007

§ 371 Date: Dec. 12, 2024

(51) Int. Cl. H04B 7/06; H04W 52/36

(52) U.S. Cl. CPC H04B 7/0626; H04W 52/367

(57) ABSTRACT

Various aspects of the present disclosure generally relate to wireless communication. In some aspects, a user equipment (UE) may receive, from a network node, a coherent joint transmission (CJT) configuration associated with a transmission reception point level (TRP-level) power restriction. The UE may transmit, to the network node, CJT channel state information (CSI). The UE may receive, from the network node and based at least in part on the CJT configuration and the CJT CSI, a subsequent downlink CJT that is subjected to the TRP-level power restriction. Numerous other aspects are described.

### FIELD OF THE DISCLOSURE

Aspects of the present disclosure generally relate to wireless communication and to techniques and apparatuses for coherent joint transmissions (CJTs) with transmission reception point (TRP) level power restrictions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, a coherent joint transmission (CJT) configuration associated with a transmission reception point level (TRP-level) power restriction; transmit, to the network node, CJT channel state information (CSI); and receive, from the network node and based at least in part on the CJT configuration and the CJT CSI, a subsequent downlink CJT that is subjected to the TRP-level power restriction.

In some implementations, an apparatus for wireless communication at a network node includes a memory and one or more processors, coupled to the memory, configured to: transmit, to a UE, a CJT configuration associated with a TRP-level power restriction; receive, from the UE, CJT CSI; and transmit, to the UE and based at least in part on the CJT configuration and the CJT CSI, a subsequent downlink CJT that is subjected to the TRP-level power restriction.

In some implementations, a method of wireless communication performed by a UE includes receiving, from a network node, a CJT configuration associated with a TRP-level power restriction; transmitting, to the network node, CJT CSI; and receiving, from the network node and based at least in part on the CJT configuration and the CJT CSI, a subsequent downlink CJT that is subjected to the TRP-level power restriction.

In some implementations, a method of wireless communication performed by a network node includes transmitting, to a UE, a CJT configuration associated with a TRP-level power restriction; receiving, from the UE, CJT CSI; and transmitting, to the UE and based at least in part on the CJT configuration and the CJT CSI, a subsequent downlink CJT that is subjected to the TRP-level power restriction.

In some implementations, a non-transitory computer-readable medium storing a set of instructions for wireless communication includes one or more instructions that, when executed by one or more processors of a UE, cause the UE to: receive, from a network node, a CJT configuration associated with a TRP-level power restriction; transmit, to the network node, CJT CSI; and receive, from the network node and based at least in part on the CJT configuration and the CJT CSI, a subsequent downlink CJT that is subjected to the TRP-level power restriction.

In some implementations, a non-transitory computer-readable medium storing a set of instructions for wireless communication includes one or more instructions that, when executed by one or more processors of a network node, cause the network node to: transmit, to a UE, a CJT configuration associated with a TRP-level power restriction; receive, from the UE, CJT CSI; and transmit, to the UE and based at least in part on the CJT configuration and the CJT CSI, a subsequent downlink CJT that is subjected to the TRP-level power restriction.

In some implementations, an apparatus for wireless communication includes means for receiving, from a network node, a CJT configuration associated with a TRP-level power restriction; means for transmitting, to the network node, CJT CSI; and means for receiving, from the network node and based at least in part on the CJT configuration and the CJT CSI, a subsequent downlink CJT that is subjected to the TRP-level power restriction.

In some implementations, an apparatus for wireless communication includes means for transmitting, to a UE, a CJT configuration associated with a TRP-level power restriction; means for receiving, from the UE, CJT CSI; and means for transmitting, to the UE and based at least in part on the CJT configuration and the CJT CSI, a subsequent downlink CJT that is subjected to the TRP-level power restriction.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of coherent joint transmissions (CJTs), in accordance with the present disclosure.

FIGS. 5A-5B are diagrams illustrating examples of CJTs, in accordance with the present disclosure.

FIG. 6 is a diagram illustrating an example of a quantization, in accordance with the present disclosure.

FIGS. 7-9 are diagrams illustrating examples associated with CJTs with transmission reception point level (TRP-level) power restrictions, in accordance with the present disclosure.

FIGS. 10-11 are diagrams illustrating example processes associated with CJTs with TRP-level power restrictions, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

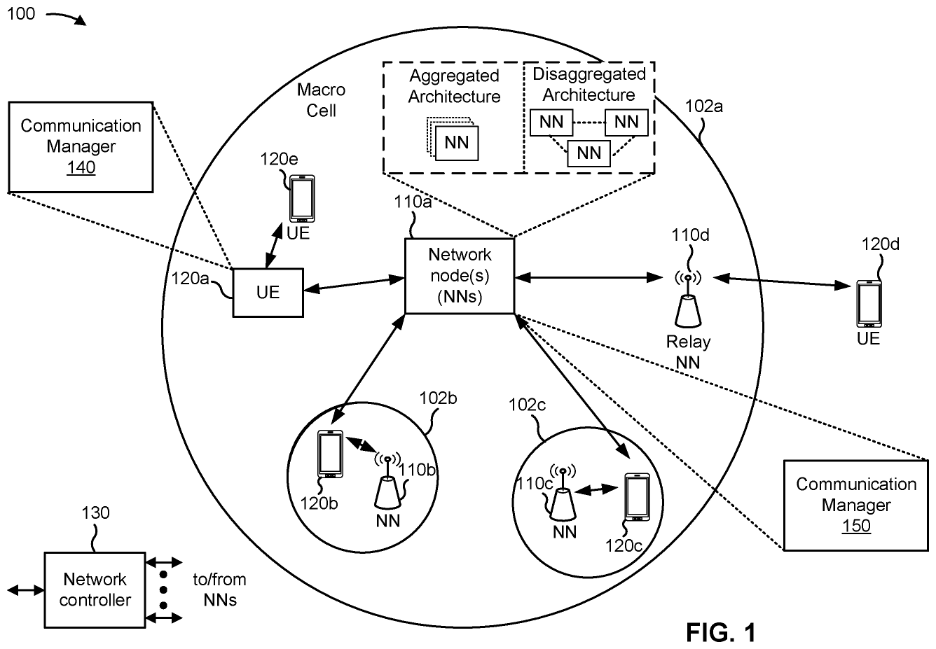

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a ULE 120a, a UE 120b, a UE 120c, a UE 120d, and a ULE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (JAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a coherent joint transmission (CJT) configuration associated with a transmission reception point level (TRP-level) power restriction; transmit, to the network node, CJT channel state information (CSI); and receive, from the network node and based at least in part on the CJT configuration and the CJT CSI, a subsequent downlink CJT that is subjected to the TRP-level power restriction. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a CJT configuration associated with a TRP-level power restriction; receive, from the UE, CJT CSI; and transmit, to the UE and based at least in part on the CJT configuration and the CJT CSI, a subsequent downlink CJT that is subjected to the TRP-level power restriction. Additionally, or alternatively, the communication manager 150 may perform one or more other operations described herein.

As indicated above, FIG. 1 is provided as an example. Other examples may differ from what is described with regard to FIG. 1.

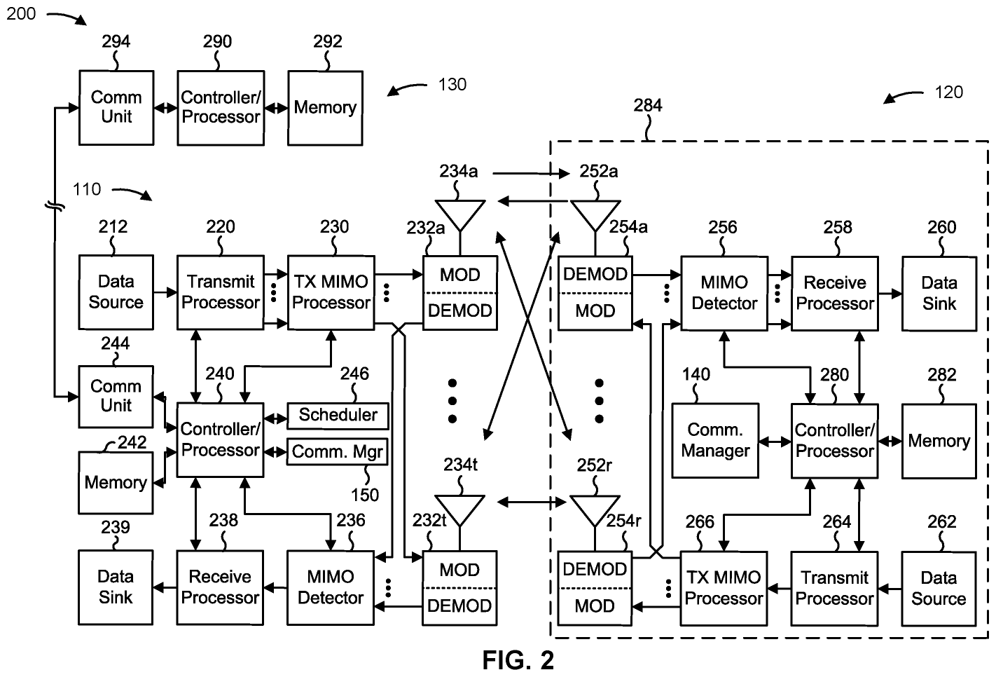

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

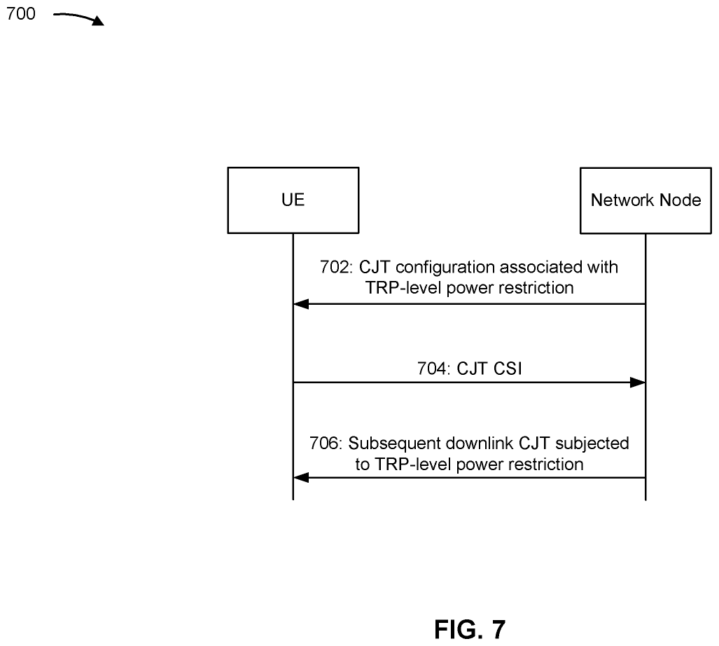

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

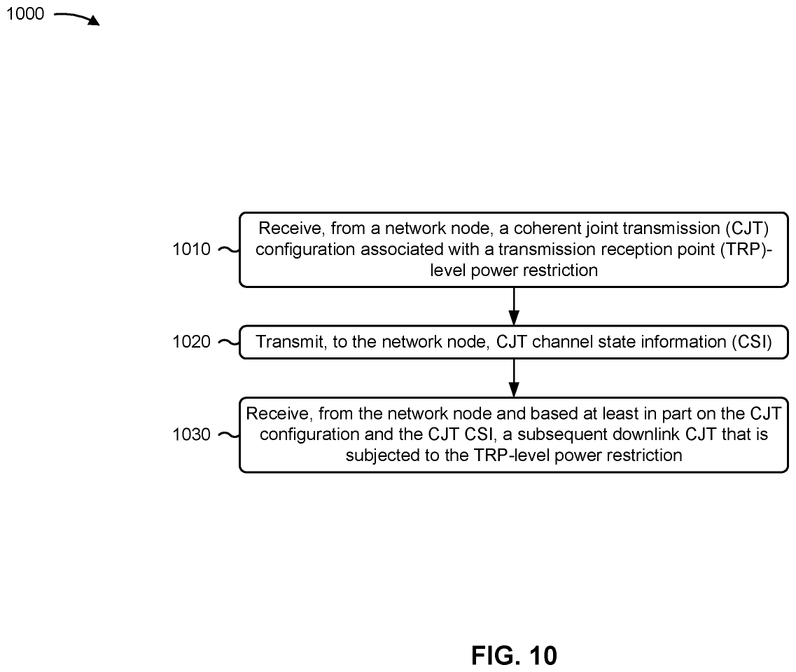

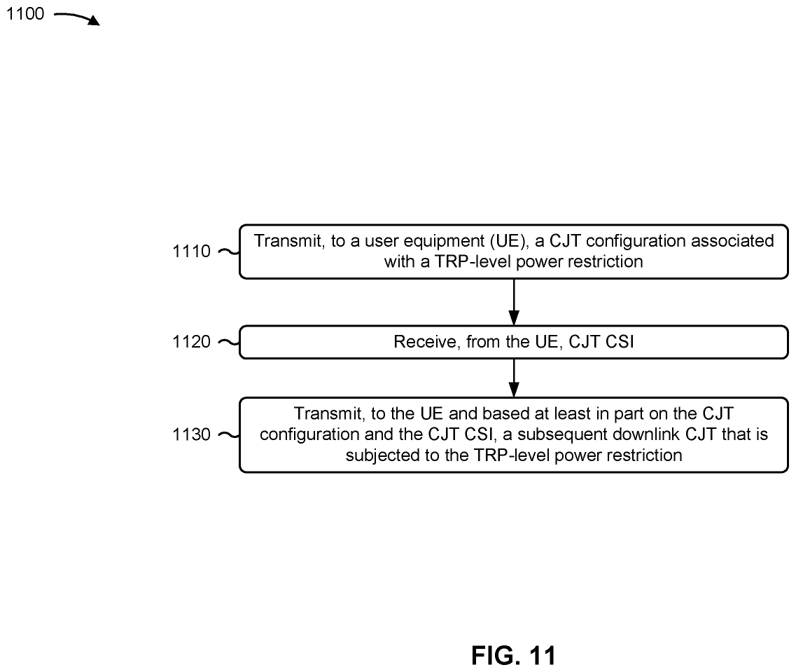

The controller/processor 240 of the network node 110, the controller/processor 280 of the UE 120, and/or any other component(s) of FIG. 2 may perform one or more techniques associated with CJTs with TRP-level power restrictions, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, a CJT configuration associated with a TRP-level power restriction; means for transmitting, to the network node, CJT CSI; and/or means for receiving, from the network node and based at least in part on the CJT configuration and the CJT CSI, a subsequent downlink CJT that is subjected to the TRP-level power restriction. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, a CJT configuration associated with a TRP-level power restriction; means for receiving, from the UE, CJT CSI; and/or means for transmitting, to the UE and based at least in part on the CJT configuration and the CJT CSI, a subsequent downlink CJT that is subjected to the TRP-level power restriction. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base-station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

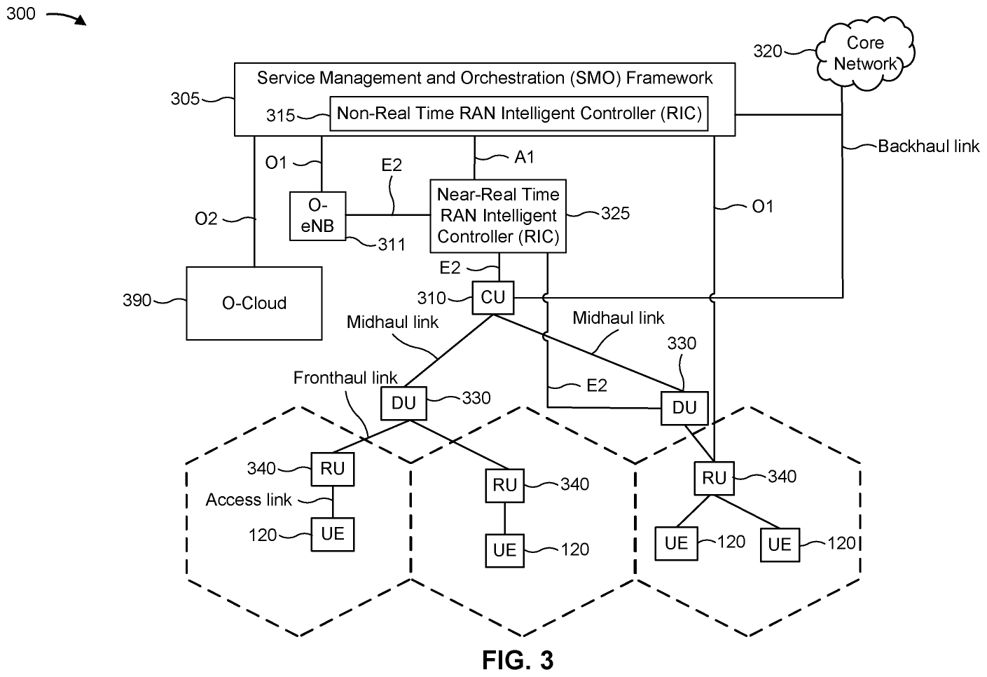

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A coherent joint transmission (CJT) may involve a channel state information (CSI) acquisition. The CSI acquisition may be for CJT targeting FR1 and up to four TRPs. The CSI acquisition may assume an ideal backhaul and synchronization, as well as a same quantity of antenna ports across TRPs. A Type-II codebook refinement may be defined for CJT for multiple TRPs (mTRP) targeting frequency division duplexing (FDD) and an associated CSI reporting. The Type-II codebook refinement may consider a throughput-overhead trade-off. A maximum quantity of channel state information reference signal (CSI-RS) ports per resource may be defined (e.g., a maximum of 32 CSI-RS ports per resource). A CJT enhanced Type-II (eType-II) CSI may enable a larger quantity of ports for CJT in low-frequency bands, as compared to Type-II, and may be associated with distributed TRPs/panels. For a single-TRP/-panel with, for example, 32 ports, an antenna array size may be large for a practical deployment.

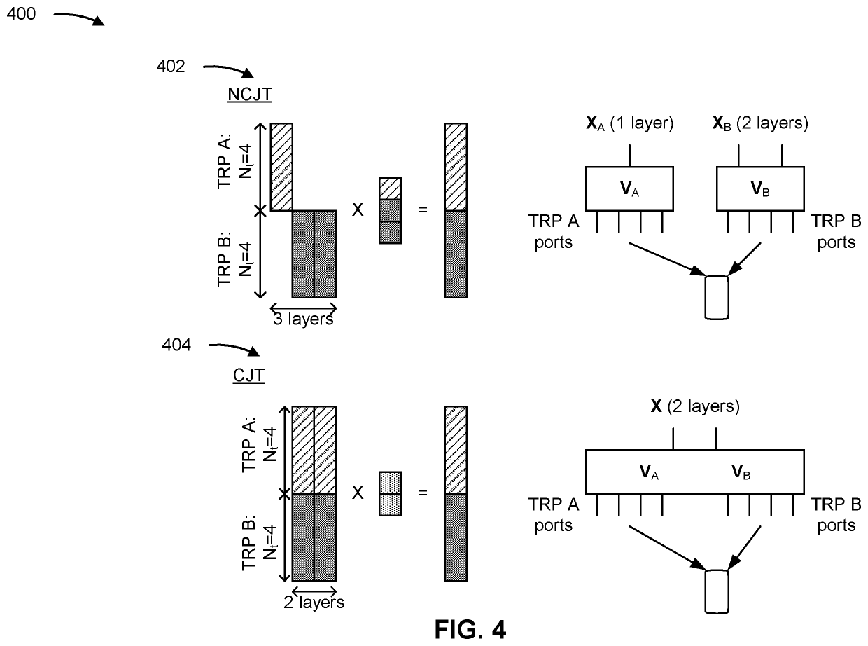

FIG. 4 is a diagram illustrating examples 400 of CJTs, in accordance with the present disclosure.

As shown by reference number 402, a non-coherent joint transmission (NCJT) from a network node to a UE may be based at least in part on a spatial division multiplexing. In an NCJT, data may be precoded separately on different TRPs (e.g., TRP A and TRP B). Data precoded separately on different TRPs may be represented by the following:

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] ,$$

where V_{A} and V_{B} are precoders, and X_{A} and X_{B} are data. Further, precoder

$$( {N}_{t}^{T R P} \times {RI}^{T R P} ) {V}_{A} : 4 \times 1$$

and V_{B}: 4×2, and data (RI^{TRP}×1) X_{A}: 1×1 and X_{B}: 2×1. In this example, X_{A} is one layer and X_{B} is two layers, X_{A} may be associated with V_{A} and TRP A ports, and X_{B} may be associated with V_{B} and TRP B ports. Further, in this example, for both TRP A and TRP B, Nₜ=4.

As shown by reference number 404, for a CJT from a network node to a UE, data may be precoded jointly on different TRPs (e.g., TRP A and TRP B). Data precoded jointly on different TRPs may be represented by the following:

$$[ \begin{matrix}{V}_{A} \\ {V}_{B}\end{matrix} ] \cdot X = [ \begin{matrix}{V}_{A} X \\ {V}_{B} X\end{matrix} ] ,$$

where V_{A} and V_{B} are precoders, and X is associated with a quantity of layers. Further, precoder

$$( {N}_{t}^{TRP} \times {RI}^{CJT} ) {V}_{A} : 4 \times 2$$

and V_{B}: 4×2, and data (RI^{CJT}×1) X: 2×1. In this example, X is two, X is associated with V_{A} and TRP A ports, and X is associated with V_{B} and TRP B ports. Further, in this example, for both TRP A and TRP B, Nₜ=4.

As indicated above, FIG. 4 is provided as an example. Other examples may differ from what is described with regard to FIG. 4.

For eType-II CSI, which may support up to rank 4, a precoder for one layer may be based at least in part on the following:

$$W = {W}_{1} \times {\tilde{W}}_{2} \times {W}_{f}^{H} .$$

For each layer, the precoder across a number of N₃ precoding matrix indicator (PMI) subbands may be an Nₜ×N₃ matrix W. Spatial domain (SD) bases W₁ (discrete Fourier transform (DFT) bases) may be an Nₜ×2L matrix. W₁ may be layer-common. Nₜ=2N₁O₁N₂O₂, which may indicate a quantity of Tx antennas with O₁ and O₂ oversampling), may be RRC configured, where N₁ and N₂ are based at least in part on a quantity of antennas in horizontal and vertical directions, respectively, and O₁ and O₂ are oversampling values. L={2,4,6} (a quantity of beams) may be RRC configured. Frequency domain (FD) bases W_{f} (DFT bases) may be an M×N₃ matrix. W_{f} may be layer-specific. M (a quantity of FD bases) may be rank-pair specific, e.g., M₁=M₂ for rank={1,2}, and M₃=M₄ for rank={3,4}. M₁ or M₃ may be RRC configured. Coefficients \tilde{W}₂ may be a 2L×M matrix, where the \tilde{W}₂ coefficients may be quantized. \tilde{W}₂ may be layer-specific. For each layer, a UE may report up to K₀ non-zero coefficients, where K₀ may be RRC configured. Across a plurality of layers (e.g., all layers), the UE may report up to 2K₀ non-zero coefficients. Unreported coefficients may be set to zeros.

A framework for CJT may include a first scenario involving co-located TRPs/panels (e.g., intra-site) or a second scenario involving distributed TRPs (e.g., inter-site). The co-located TRPs or the distributed TRPs may be represented by TRP #A and TRP #B. Within the first scenario, a first sub-scenario may involve a same orientation (e.g., a Type-I multi-panel). In the first sub-scenario, a precoder (one layer) may be associated with a joint SD and FD. The precoder may be associated with a joint codebook. The precoder may be represented by the following:

$$[ \begin{matrix}{W}^{TRP \# A} \\ {W}^{TRP \# B}\end{matrix} ] = [ \begin{matrix}{W}_{1} & 0 \\ 0 & {W}_{1}\end{matrix} ] \times {\tilde{W}}_{2} \times {W}_{f}^{H} .$$

Within the first scenario, a second sub-scenario may involve different orientations (e.g., inter-sector). In the second sub-scenario, a precoder (one layer) may be associated with a joint FD and a separate SD. The precoder may be associated with a joint codebook. The precoder may be represented by the following:

$$[ \begin{matrix}{W}^{TRP \# A} \\ {W}^{TRP \# B}\end{matrix} ] = [ \begin{matrix}{W}_{1 , A} & 0 \\ 0 & {W}_{1 , B}\end{matrix} ] \times {\tilde{W}}_{2} \times {W}_{f}^{H} .$$

The second scenario may involve a separate SD and FD with co-phase/amplitude (q). In the second scenario, a precoder (one layer) may be associated with a semi-separate codebook. The precoder may be represented by the following:

$$[ \begin{matrix}{W}^{TRP \# A} \\ {qW}^{TRP \# B}\end{matrix} ] = [ \begin{matrix}{W}_{1 , A} \times {\tilde{W}}_{2 , A} \times {W}_{f , A}^{H} \\ {W}_{1 , B} \times q {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & q {\tilde{W}}_{2 , B}\end{matrix} ] \times [ \begin{matrix}{W}_{f , A}^{H} \\ {W}_{f , B}^{H}\end{matrix} ] .$$

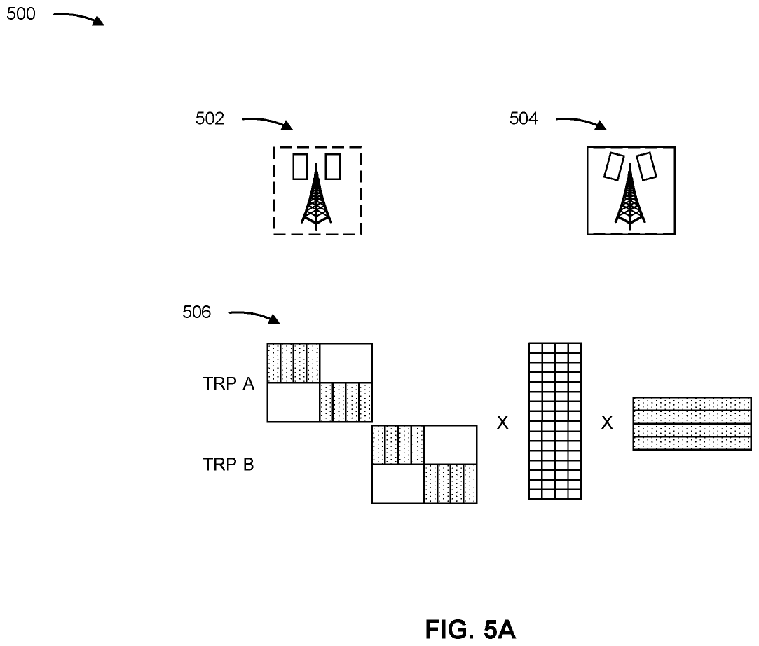

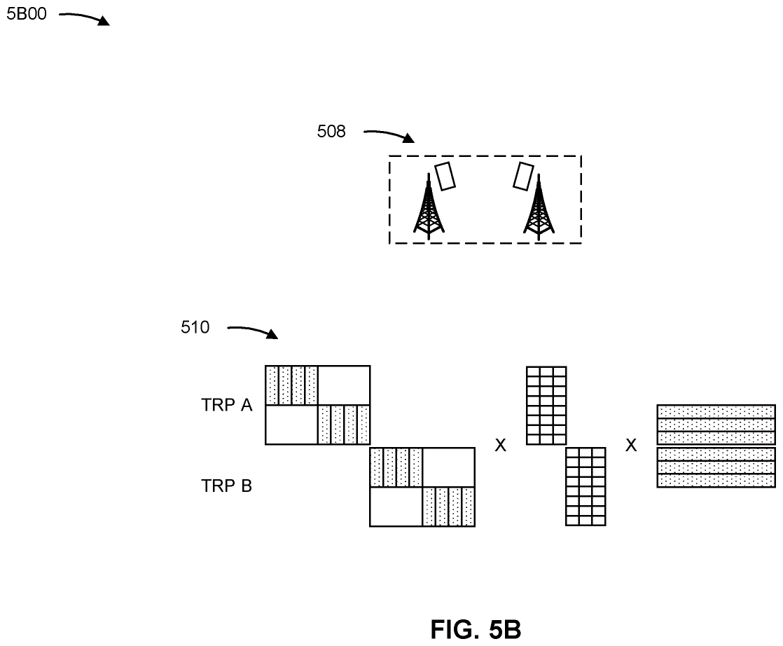

FIGS. 5A-5B are diagrams illustrating examples 500 of CJTs, in accordance with the present disclosure.

As shown in FIG. 5A, and by reference number 502, a framework for CJT may include co-located TRPs/panels (e.g., intra-site) with a same orientation. As shown by reference number 504, a framework for CJT may include co-located TRPs/panels (e.g., intra-site) with different orientations (e.g., inter-sector). As shown by reference number 506, for co-located TRPs/panels (e.g., intra-site), a joint codebook may be used. As shown in FIG. 5B, and by reference number 508, a framework for CJT may include distributed TRPs (e.g., inter-site). As shown by reference number 510, for distributed TRPs (e.g., inter-site), a (semi-)separate codebook may be used.

As indicated above, FIGS. 5A-5B are provided as examples. Other examples may differ from what is described with regard to FIGS. 5A-5B.

A codebook subset restriction (CBSR) may be used to avoid/reduce interference with respect to certain directions. For the CBSR of an eType-II codebook, a network node may configure a bit sequence B=B₁B₂ for a UE, for an FD-average power restriction of certain SD bases. B₁ may represent four selected SD-oversampling groups, with

$$⌈ {log}_{2} ( \begin{matrix}{O}_{1} {O}_{2} \\ 4\end{matrix} ) ⌉ bits .$$

For example, B₁ may be 11 bits for oversampling factor O₁=4 and O₂=4. B₂ may represent the power restriction of each spatial basis in selected SD-oversampling groups. Two bits (soft restriction) may be used to represent a maximum amplitude γᵢ of each SD basis i, for both polarizations p=0,1. For four SD-oversampling groups, each with N₁N₂ SD bases, 8N₁N₂ bits may be used in total for B₂

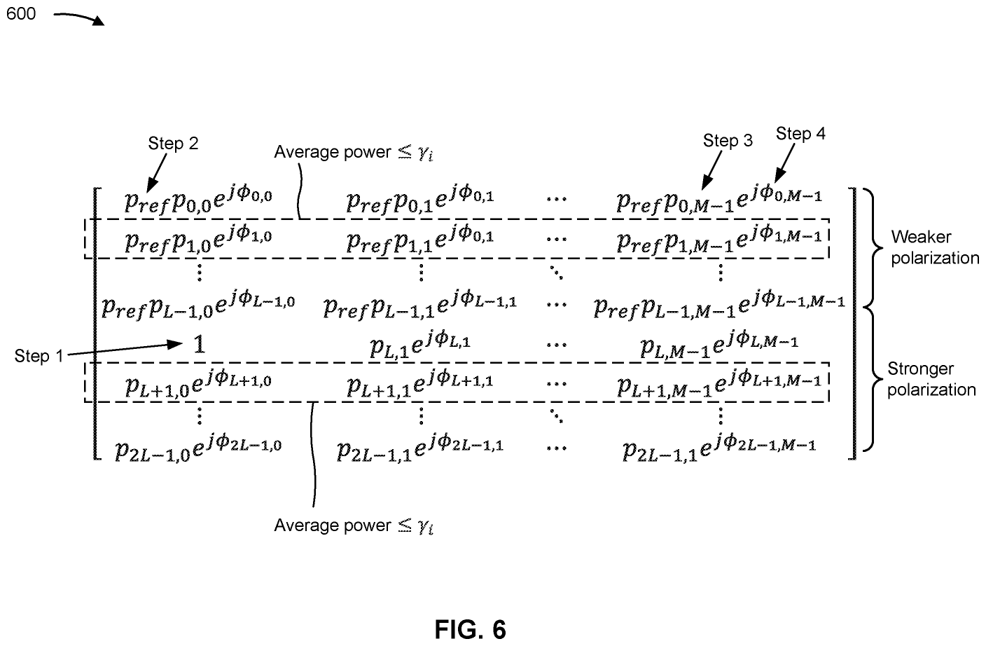

FIG. 6 is a diagram illustrating an example 600 of a quantization, in accordance with the present disclosure.

As shown in FIG. 6, for layer-l, a UE may quantize non-zero coefficients (NZCs) of \tilde{W}₂ based at least in part on a layer-independent quantization. In a first step, for a strongest coefficient, the UE may report a corresponding index. The UE may not quantize the strongest coefficient since the strongest coefficient is one. The strongest coefficient may be used as the reference for the stronger polarization. In a second step, the UE may determine a reference power (p_{ref}) for the weaker polarization. The UE may perform a quantization with 4 bits from 0 dB with a −1.5 dB (in power) step size. In a third step, the UE may determine a differential amplitude (M). The UE may perform a quantization with 3 bits from 0 dB with a −3 dB (in power) step size. In a fourth step, the UE may perform a phase quantization (ϕ), where the UE may perform a quantization with a 16 phase-shift keying (PSK) alphabet (which may be an improvement over a Type II with an 8 PSK alphabet).

As indicated above, FIG. 6 is provided as an example. Other examples may differ from what is described with regard to FIG. 6.

An average coefficient amplitude may be restricted as follows:

$$\sqrt{\frac{1}{{Σ}_{f = 0}^{{M}_{υ} - 1} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + p L , f}^{( 2 )} )}^{2}} \leq {γ}_{i + p L} ,$$

where l represents a layer, i represents an SD basis (where L is a quantity of SD bases selected), p=0 or 1 represents the two antenna polarizations, f represents an FD basis (where Mᵥ is a quantity of FD bases selected for rank-v),

$${k}_{l , i + pL , f}^{( 3 )} = 0$$

or 1 (from an NZC bitmap), and γ_{i+pL} is a maximum average coefficient amplitude for SD basis i at both polarizations.

A UE-reported eType-II CJT CSI, which may be associated with either a joint codebook or a separate codebook, may result in an unequal downlink transmission power amongst TRPs. However, in a network implementation, a constant downlink transmit power may be assumed for network nodes (e.g., TRPs) without downlink power control. Restricting the downlink transmission power for a plurality of TRPs equally may negate the value of the UE-reported eType-II CJT CSI, which may reduce a network performance.

In various aspects of techniques and apparatuses described herein, a UE may receive, from a network node, a CJT configuration associated with a TRP-level power restriction. The network node may be associated with a plurality of TRPs (e.g., up to four TRPs). The CJT configuration may indicate that the TRP-level power restriction is enabled. The TRP-level power restriction may be common to the plurality of TRPs, or the TRP-level power restriction may be on a per-TRP basis. The UE may receive, from the network node, an initial CJT. The UE may transmit, to the network node, a CJT CSI associated with the initial CJT. The network node may receive the CJT CSI from the UE, and based at least in part on the CJT CSI, the network node may determine to apply the TRP-level power restriction. The UE may receive, from the network node and based at least in part on the CJT configuration and the CJT CSI, a subsequent downlink CJT that is subjected to the TRP-level power restriction. The initial CJT may be a first CJT, and the subsequent downlink CJT may be a second CJT. As a result, the TRP-level power restriction may enable the network node to perform CJT transmissions with a certain power that is suitable based at least in part on a UE-reported CJT CSI, thereby improving a network performance.

FIG. 7 is a diagram illustrating an example 700 associated with CJTs with TRP-level power restrictions, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive, from the network node, a CJT configuration associated with a TRP-level power restriction. The CJT configuration may indicate that the TRP-level power restriction is not enabled. For example, the network node may be capable of implementing a downlink power control, in which case the TRP-level power restriction may not be needed. Alternatively, the CJT configuration may indicate that the TRP-level power restriction is enabled. The network node may be capable of applying the TRP-level power restriction to CJTs to the UE.

In some aspects, the TRP-level power restriction may be a common power restriction for a plurality of TRPs associated with the network node. The plurality of TRPs may be associated with a same maximum transmission power in accordance with the common power restriction. In some aspects, the TRP-level power restriction may be a per-TRP power restriction for the plurality of TRPs associated with the network node. A maximum transmission power may be different among TRPs of the plurality of TRPs. In some aspects, the TRP-level power restriction may be a per-polarization power restriction. The same maximum transmission power may be configured for either a first polarization or a second polarization of a certain TRP of the plurality of TRPs associated with the network node. In some aspects, the TRP-level power restriction may be a TRP-group-level power restriction. A group of TRPs from the plurality of TRPs associated with the network node may be subjected to the TRP-group-level power restriction. In some aspects, the CJT configuration may indicate whether or not the TRP-level power restriction is enabled, and if enabled, whether the TRP-level power restriction is associated with the common power restriction, the per-TRP power restriction, the per-polarization restriction, and/or the TRP-group-level power restriction.

As shown by reference number 704, the UE may transmit, to the network node, CJT CSI. The UE may receive an initial CJT from the network node, and the ULE may transmit the CJT CSI based at least in part on the initial CJT. The CJT CSI may indicate a joint codebook or a separate codebook. More specifically, the CJT CSI may indicate \tilde{W}₂ coefficients associated with the joint codebook or the separate codebook. The joint codebook may be joint for the plurality of TRPs associated with the network node (e.g., TRP A and TRP B), whereas the separate codebook may be separate for the plurality of TRPs associated with the network node. The initial CJT may not be associated with the TRP-level power restriction.

As shown by reference number 706, the UE may receive, from the network node and based at least in part on the CJT configuration and the CJT CSI, a subsequent downlink CJT that is subjected to the TRP-level power restriction. The network node may receive the CJT CSI from the UE, and based at least in part on the CJT CSI, the network node may determine to apply the TRP-level power restriction. The TRP-level power restriction may be the common power restriction, the per-TRP power restriction, the per-polarization restriction, and/or the TRP-group-level power restriction. The network node may apply the TRP-level power restriction to the subsequent downlink CJT that is transmitted to the UE. The network node, by applying the TRP-level power restriction, may reduce a transmission power associated with the subsequent downlink CJT. The network node may determine the transmission power based at least in part on precoder coefficients (e.g., the \tilde{W}₂ coefficients) indicated by the CJT CSI, and the transmission power may be associated with a per-TRP restriction and/or a per-polarization restriction.

As indicated above, FIG. 7 is provided as an example. Other examples may differ from what is described with regard to FIG. 7.

In some aspects, when a network node is configured to implement a downlink power control, no TRP-level power restriction may be needed for a UE-reported CJT CSI. The network node may configure the UE with an RRC parameter, which may indicate whether a TRP-level power restriction should be applied by the TRP for the reported CJT CSI.

In some aspects, the UE may transmit, to the network node, a UE report with a TRP-level power-restricted CJT CSI. In a first option, a common power restriction may be associated with a plurality of TRPs (e.g., all TRPs) associated with the network node. The common power restriction may or may not be configured by the network node. A configuration associated with the common power restriction may indicate the same power for the plurality of UEs. In the first option, for each TRP, the power restriction may be common. The power restriction may be commonly applied by the TRPs for downlink transmissions. Each TRP may have the same maximum allowed transmission power. In a second option, a per-TRP power restriction may be configured. For example, a first TRP may be associated with a first maximum allowed transmission power, and a second TRP may be associated with a second maximum allowed transmission power that is different from the first maximum allowed transmission power. For the first option and/or the second option, the TRP power restriction may further be per-polarization restricted. For example, a same maximum value γ may be configured for either polarization of the same TRP.

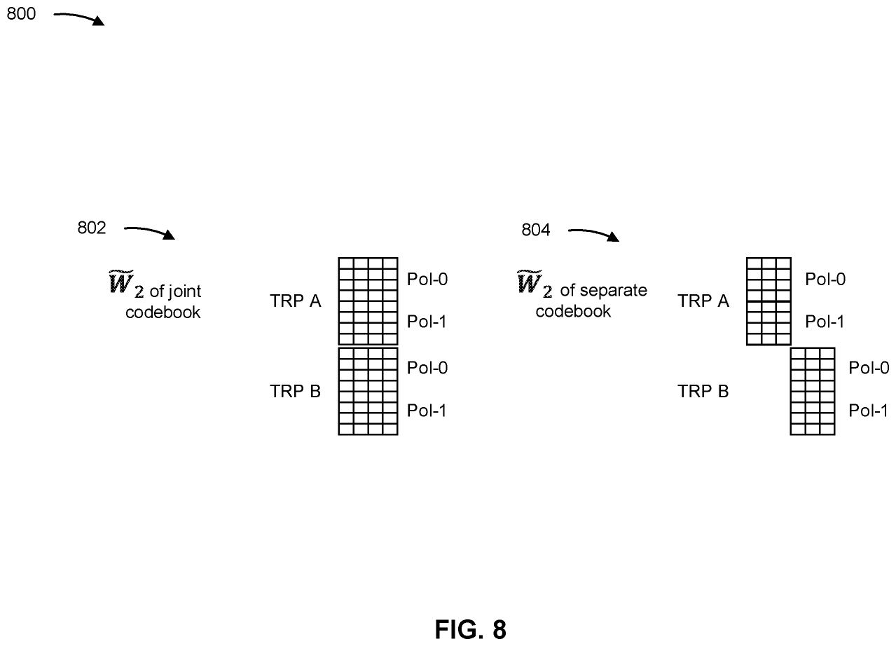

FIG. 8 is a diagram illustrating an example 800 associated with CJTs with TRP-level power restrictions, in accordance with the present disclosure.

As shown by reference number 802, a UE may report \tilde{W}₂ coefficients of a joint codebook to a first TRP (TRP A) and a second TRP (TRP B). As shown by reference number 804, the UE may report \tilde{W}₂ coefficients of a separate codebook to the first TRP and the second TRP. In either case, the first TRP and the second TRP may implement a TRP power restriction that is per-polarization restricted. The first TRP may be associated with a first polarization (Pol 0) and a second polarization (Pol 1). The second TRP may be associated with the first polarization and the second polarization. The \tilde{W}₂ coefficients may be associated with a precoder, which may be used by the first TRP and/or the second TRP for downlink transmissions.

As indicated above, FIG. 8 is provided as an example. Other examples may differ from what is described with regard to FIG. 8.

In some aspects, a power determined by related \tilde{W}₂ coefficients may be per-TRP restricted in accordance with the following.

$$\sqrt{\frac{1}{{Σ}_{i for this TRP} {Σ}_{p = 0}^{1} {Σ}_{f = 0}^{M - 1} {Z}_{l , i + p L , f}} {\sum }_{i for this TRP} {\sum }_{p = 0}^{1} {\sum }_{f = 0}^{M - 1} {{Z}_{l , i + p L , f} ( {p}_{l , p}^{ref} {p}_{l , i + pL , f} )}^{2}} \leq {γ}_{this TRP} .$$

When a common power restriction is associated with a plurality of TRPs (e.g., all TRPs), a maximum value γ_{this TRP} may be the same for all TRPs. In some cases, a per-TRP power restriction may be applied by a network node to CJTs to a UE. Here, l indicates a layer index, i indicates an SD basis index (where p is polarization 0 or 1, and L is a quantity of SD bases selected for this TRP), f indicates an FD basis index, and M indicates a quantity of FD bases selected for this TRP. In terms of amplitude,

$${p}_{l , p}^{ref}$$

indicates a reference differential amplitude of \tilde{W}₂ coefficients associated with polarization p on layer l, and p_{l,i+pL,f} indicates a differential amplitude of one \tilde{W}₂ coefficient associated with SD basis i, polarization p, and FD basis f. Further, Z_{l,i+pL,f}=0 or 1, which may be from an NZC bitmap.

In some aspects, a power determined by related \tilde{W}₂ coefficients may be per-TRP and per-polarization restricted in accordance with the following:

$$\sqrt{\frac{1}{{Σ}_{i for this TRP} {Σ}_{f = 0}^{M - 1} {Z}_{l , i + p L , f}} {\sum }_{i for this TRP} {\sum }_{f = 0}^{M - 1} {{Z}_{l , i + p L , f} ( {p}_{l , p}^{ref} {p}_{l , i + pL , f} )}^{2}} \leq {γ}_{this TRP , p}$$

When a common power restriction is associated with a plurality of TRPs (e.g., all TRPs), a maximum value γ_{this TRP,p} may be the same for all TRPs and both polarizations. In some cases, a per-TRP and per-polarization power restriction may be applied by a network node to CJTs to a UE (either equal or not power restriction value γ_{this TRP,p} for the two polarizations p=0,1). Here, 1 indicates the layer index, i indicates the SD basis index (where p is polarization 0 or 1, and L is the quantity of SD bases selected for this TRP), f indicates the FD basis index, and M indicates the quantity of FD bases selected for this TRP. In terms of amplitude,

$${p}_{l , p}^{ref}$$

indicates the reference differential amplitude of \tilde{W}₂ coefficients associated with polarization p, and p_{l,i+pL,f} indicates the differential amplitude of one \tilde{W}₂ coefficient associated with SD basis i and FD basis f. Further, Z_{l,i+pL,f}=0 or 1, which may be from the NZC bitmap. Further, a configured power restriction γ_{this TRP,0}=γ_{this TRP,1} for the same TRP with the two polarizations p=0,1.

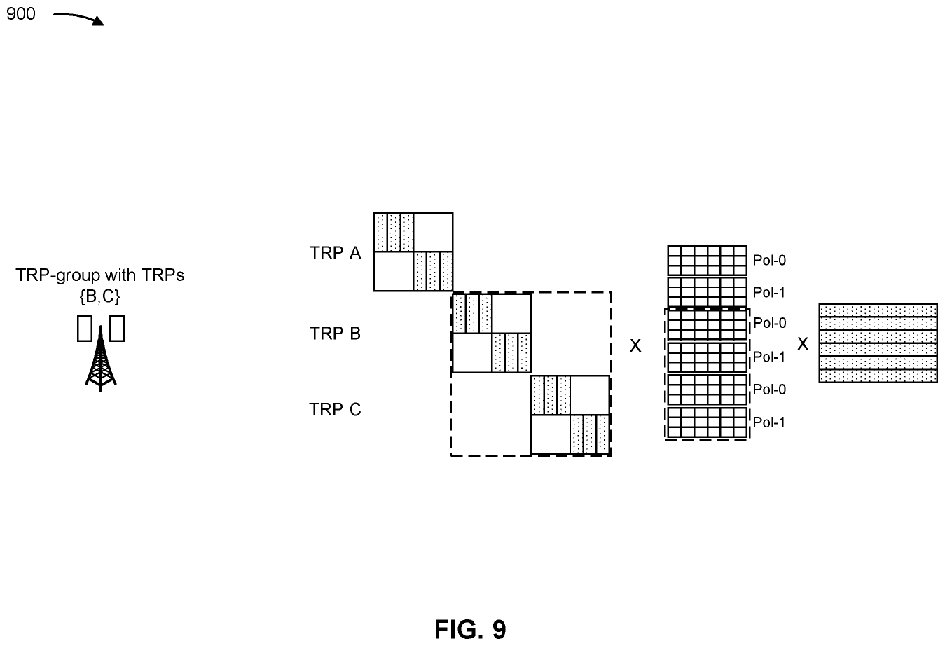

FIG. 9 is a diagram illustrating an example 900 associated with CJTs with TRP-level power restrictions, in accordance with the present disclosure.

As shown in FIG. 9, a power restriction may be TRP-group configured, which may correspond to a TRP-group-level power restriction. For example, in a multi-panel scenario, TRPs {B,C} may be configured as a TRP group, and TRP A may not be within the TRP group. In this example, the power restriction may apply to TRPs {B,C} but not TRP A.

In some aspects, for a TRP-group-level power restriction, a power determined by related \tilde{W}₂ coefficients may be per-TRP restricted in accordance with the following:

$$\sqrt{\frac{1}{{Σ}_{i for this TRP group} {Σ}_{p = 0}^{1} {Σ}_{f = 0}^{M - 1} {Z}_{l , i + p L , f}} {\sum }_{i for this TRP group} {\sum }_{p = 0}^{1} {\sum }_{f = 0}^{M - 1} {{Z}_{l , i + p L , f} ( {p}_{l , p}^{ref} {p}_{l , i + pL , f} )}^{2}} \leq {γ}_{this TRP group} .$$

In some aspects, for a TRP-group-level power restriction, a power determined by related \tilde{W}₂ coefficients may be per-TRP and per-polarization restricted in accordance with the following:

$$\sqrt{\frac{1}{{Σ}_{i for this TRP group} {Σ}_{f = 0}^{M - 1} {Z}_{l , i + p L , f}} {\sum }_{i for this TRPgroup} {\sum }_{f = 0}^{M - 1} {{Z}_{l , i + p L , f} ( {p}_{l , p}^{ref} {p}_{l , i + pL , f} )}^{2}} \leq {γ}_{this TRP group , p .}$$

As indicated above, FIG. 9 is provided as an example. Other examples may differ from what is described with regard to FIG. 9.

In some aspects, with respect to a CJT CSI associated with a separate codebook, whether a co-amplitude exists may depend on whether a first option (e.g., no TRP-level power restriction) or a second option (e.g., UE reports with a TRP-level power-restricted CJT CSI) is configured. For the first option, an explicit co-amplitude may be needed. For the second option, the co-amplitude may not be needed because a plurality of TRPs (e.g., all TRPs) may be normalized according to respective power restrictions in accordance with the following:

$$[ \begin{matrix}{W}^{TRP \# A} \\ {qW}^{TRP \# B}\end{matrix} ] = [ \begin{matrix}{W}_{1 , A} \times {\tilde{W}}_{2 , A} \times {W}_{f , A}^{H} \\ {W}_{1 , B} \times q {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & q {\tilde{W}}_{2 , B}\end{matrix} ] \times [ \begin{matrix}{W}_{f , A}^{H} \\ {W}_{f , B}^{H}\end{matrix} ] ,$$

where the coefficient q may be reported as normalized (with amplitude 1) and may only indicate a co-phase. In some aspects, the CJT CSI may indicate the separate codebook. The CJT CSI may indicate the co-amplitude. Alternatively, the CJT CSI may not indicate the co-amplitude due to the plurality of TRPs being configured with the TRP-level power restriction.

In some aspects, for a per-SD-basis (per-beam) power restriction (e.g., an eType-II CBSR), a per-TRP and per-beam power restriction may be configured as separate codebook restrictions for a CJT CSI report (e.g., when both types of power restrictions are configured, both types of power restrictions may need to be satisfied for a reported PMI).

FIG. 10 is a diagram illustrating an example process 1000 performed, for example, by a UE, in accordance with the present disclosure. Example process 1000 is an example where the UE (e.g., UE 120) performs operations associated with CJTs with TRP-level power restrictions.

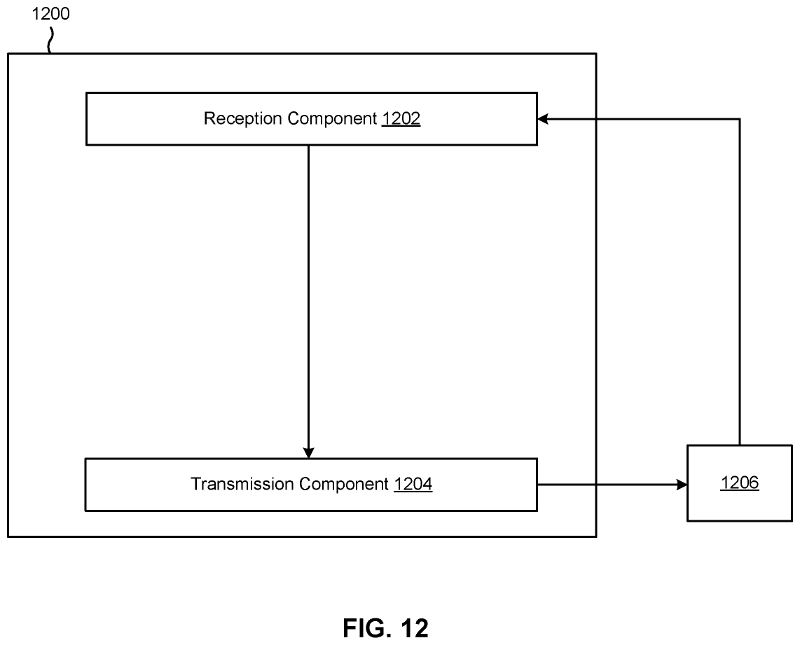

As shown in FIG. 10, in some aspects, process 1000 may include receiving, from a network node, a CJT configuration associated with a TRP-level power restriction (block 1010). For example, the UE (e.g., using reception component 1202, depicted in FIG. 12, or using antenna 252, modem 254, MIMO detector 256, receive processor 258, and/or controller/processor 280, depicted in FIG. 2) may receive, from a network node, a CJT configuration associated with a TRP-level power restriction, as described above.

As further shown in FIG. 10, in some aspects, process 1000 may include transmitting, to the network node, CJT CSI (block 1020). For example, the UE (e.g., using transmission component 1204, depicted in FIG. 12, or using controller/processor 280, transmit processor 264, TX MIMO processor 266, modem 254, and/or antenna 252, depicted in FIG. 2) may transmit, to the network node, CJT CSI, as described above.

As further shown in FIG. 10, in some aspects, process 1000 may include receiving, from the network node and based at least in part on the CJT configuration and the CJT CSI, a subsequent downlink CJT that is subjected to the TRP-level power restriction (block 1030). For example, the UE (e.g., using reception component 1202, depicted in FIG. 12, or using antenna 252, modem 254, MIMO detector 256, receive processor 258, and/or controller/processor 280, depicted in FIG. 2) may receive, from the network node and based at least in part on the CJT configuration and the CJT CSI, a subsequent downlink CJT that is subjected to the TRP-level power restriction, as described above.

Process 1000 may include additional aspects, such as any single aspect or any combination of aspects described below and/or in connection with one or more other processes described elsewhere herein.

In a first aspect, the TRP-level power restriction is a common power restriction for a plurality of TRPs associated with the network node, and the plurality of TRPs are associated with a same maximum transmission power in accordance with the common power restriction.

In a second aspect, alone or in combination with the first aspect, the TRP-level power restriction is a per-TRP power restriction for a plurality of TRPs associated with the network node, and a maximum transmission power is different among TRPs of the plurality of TRPs.

In a third aspect, alone or in combination with one or more of the first and second aspects, the TRP-level power restriction is a per-polarization power restriction, and a same maximum transmission power is configured for either a first polarization or a second polarization of a certain TRP of a plurality of TRPs associated with the network node.

In a fourth aspect, alone or in combination with one or more of the first through third aspects, a transmission power associated with precoder coefficients indicated by the CJT CSI is associated with a per-TRP restriction.

In a fifth aspect, alone or in combination with one or more of the first through fourth aspects, a transmission power associated with precoder coefficients indicated by the CJT CSI is associated with a per-TRP restriction and a per-polarization restriction.

In a sixth aspect, alone or in combination with one or more of the first through fifth aspects, the TRP-level power restriction is a TRP-group-level power restriction, and a group of TRPs from a plurality of TRPs associated with the network node are subjected to the TRP-group-level power restriction.

In a seventh aspect, alone or in combination with one or more of the first through sixth aspects, the CJT CSI is associated with a separate codebook for a plurality of TRPs associated with the network node, and the CJT CSI indicates a co-amplitude, or the CJT CSI does not indicate the co-amplitude due to the plurality of TRPs being configured with the TRP-level power restriction.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with CJTs with TRP-level power restrictions.

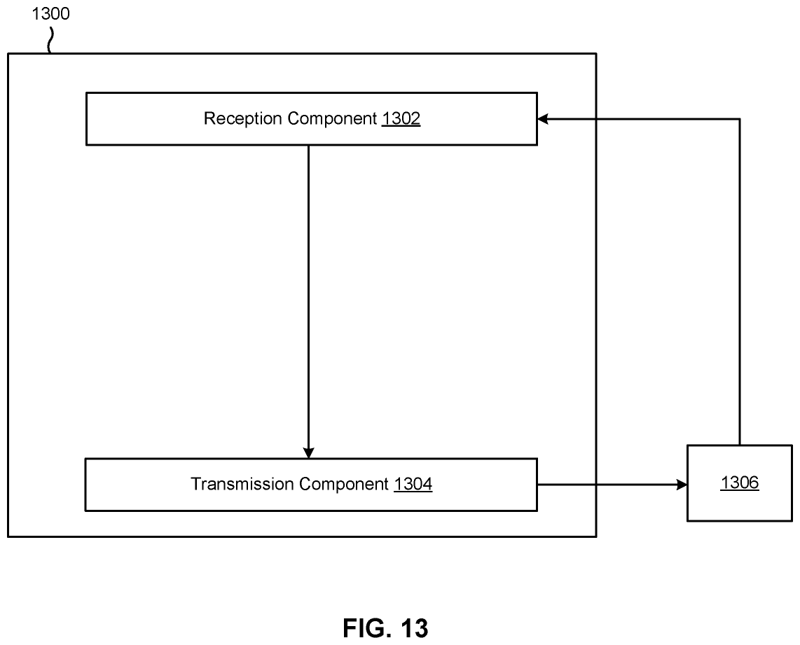

As shown in FIG. 11, in some aspects, process 1100 may include transmitting, to a UE, a CJT configuration associated with a TRP-level power restriction (block 1110). For example, the network node (e.g., using transmission component 1304, depicted in FIG. 13, or using controller/processor 240, transmit processor 220, TX MIMO processor 230, modem 232, and/or antenna 234, depicted in FIG. 2) may transmit, to a UE, a CJT configuration associated with a TRP-level power restriction, as described above.

As further shown in FIG. 11, in some aspects, process 1100 may include receiving, from the UE, CJT CSI (block 1120). For example, the network node (e.g., using reception component 1302, depicted in FIG. 13, or using antenna 234, modem 232, MIMO detector 236, receive processor 238, and/or controller/processor 240, shown in FIG. 2) may receive, from the UE, CJT CSI, as described above.

As further shown in FIG. 11, in some aspects, process 1100 may include transmitting, to the UE and based at least in part on the CJT configuration and the CJT CSI, a subsequent downlink CJT that is subjected to the TRP-level power restriction (block 1130). For example, the network node (e.g., using transmission component 1304, depicted in FIG. 13, or using controller/processor 240, transmit processor 220, TX MIMO processor 230, modem 232, and/or antenna 234, depicted in FIG. 2) may transmit, to the UE and based at least in part on the CJT configuration and the CJT CSI, a subsequent downlink CJT that is subjected to the TRP-level power restriction, as described above.

Process 1100 may include additional aspects, such as any single aspect or any combination of aspects described below and/or in connection with one or more other processes described elsewhere herein.

In a first aspect, the TRP-level power restriction is a common power restriction for a plurality of TRPs associated with the network node, and the plurality of TRPs are associated with a same maximum transmission power in accordance with the common power restriction.

In a second aspect, alone or in combination with the first aspect, the TRP-level power restriction is a per-TRP power restriction for a plurality of TRPs associated with the network node, and a maximum transmission power is different among TRPs of the plurality of TRPs.

In a third aspect, alone or in combination with one or more of the first and second aspects, the TRP-level power restriction is a per-polarization power restriction, and a same maximum transmission power is configured for either a first polarization or a second polarization of a certain TRP of a plurality of TRPs associated with the network node.

In a fourth aspect, alone or in combination with one or more of the first through third aspects, a transmission power associated with precoder coefficients indicated by the CJT CSI is associated with a per-TRP restriction.

In a fifth aspect, alone or in combination with one or more of the first through fourth aspects, a transmission power associated with precoder coefficients indicated by the CJT CSI is associated with a per-TRP restriction and a per-polarization restriction.

In a sixth aspect, alone or in combination with one or more of the first through fifth aspects, the TRP-level power restriction is a TRP-group-level power restriction, and a group of TRPs from a plurality of TRPs associated with the network node are subjected to the TRP-group-level power restriction.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a network node, a CJT configuration associated with a TRP-level power restriction. The transmission component 1204 may transmit, to the network node, CJT CSI. The reception component 1202 may receive, from the network node and based at least in part on the CJT configuration and the CJT CSI, a subsequent downlink CJT that is subjected to the TRP-level power restriction.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, a CJT configuration associated with a TRP-level power restriction. The reception component 1302 may receive, from the UE, CJT CSI. The transmission component 1304 may transmit, to the UE and based at least in part on the CJT configuration and the CJT CSI, a subsequent downlink CJT that is subjected to the TRP-level power restriction.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, a coherent joint transmission (CJT) configuration associated with a transmission reception point (TRP)-level power restriction; transmitting, to the network node, CJT channel state information (CSI); and receiving, from the network node and based at least in part on the CJT configuration and the CJT CSI, a subsequent downlink CJT that is subjected to the TRP-level power restriction.

Aspect 2: The method of Aspect 1, wherein the TRP-level power restriction is a common power restriction for a plurality of TRPs associated with the network node, and wherein the plurality of TRPs are associated with a same maximum transmission power in accordance with the common power restriction.

Aspect 3: The method of any of Aspects 1 through 2, wherein the TRP-level power restriction is a per-TRP power restriction for a plurality of TRPs associated with the network node, wherein a maximum transmission power is different among TRPs of the plurality of TRPs.

Aspect 4: The method of any of Aspects 1 through 3, wherein the TRP-level power restriction is a per-polarization power restriction, and wherein a same maximum transmission power is configured for either a first polarization or a second polarization of a certain TRP of a plurality of TRPs associated with the network node.

Aspect 5: The method of any of Aspects 1 through 4, wherein a transmission power associated with precoder coefficients indicated by the CJT CSI is associated with a per-TRP restriction.

Aspect 6: The method of any of Aspects 1 through 5, wherein a transmission power associated with precoder coefficients indicated by the CJT CSI is associated with a per-TRP restriction and a per-polarization restriction.

Aspect 7: The method of any of Aspects 1 through 6, wherein the TRP-level power restriction is a TRP-group-level power restriction, and wherein a group of TRPs from a plurality of TRPs associated with the network node are subjected to the TRP-group-level power restriction.

Aspect 8: The method of any of Aspects 1 through 7, wherein the CJT CSI is associated with a separate codebook for a plurality of TRPs associated with the network node, and wherein the CJT CSI indicates a co-amplitude, or the CJT CSI does not indicate the co-amplitude due to the plurality of TRPs being configured with the TRP-level power restriction.

Aspect 9: A method of wireless communication performed by a network node, comprising: transmitting, to a user equipment (UE), a coherent joint transmission (CJT) configuration associated with a transmission reception point (TRP)-level power restriction; receiving, from the UE, CJT channel state information (CSI); and transmitting, to the UE and based at least in part on the CJT configuration and the CJT CSI, a subsequent downlink CJT that is subjected to the TRP-level power restriction.

Aspect 10: The method of Aspect 9, wherein the TRP-level power restriction is a common power restriction for a plurality of TRPs associated with the network node, and wherein the plurality of TRPs are associated with a same maximum transmission power in accordance with the common power restriction.

Aspect 11: The method of any of Aspects 9 through 10, wherein the TRP-level power restriction is a per-TRP power restriction for a plurality of TRPs associated with the network node, wherein a maximum transmission power is different among TRPs of the plurality of TRPs.

Aspect 12: The method of any of Aspects 9 through 11, wherein the TRP-level power restriction is a per-polarization power restriction, and wherein a same maximum transmission power is configured for either a first polarization or a second polarization of a certain TRP of a plurality of TRPs associated with the network node.

Aspect 13: The method of any of Aspects 9 through 12, wherein a transmission power associated with precoder coefficients indicated by the CJT CSI is associated with a per-TRP restriction.

Aspect 14: The method of any of Aspects 9 through 13, wherein a transmission power associated with precoder coefficients indicated by the CJT CSI is associated with a per-TRP restriction and a per-polarization restriction.

Aspect 15: The method of any of Aspects 9 through 14, wherein the TRP-level power restriction is a TRP-group-level power restriction, and wherein a group of TRPs from a plurality of TRPs associated with the network node are subjected to the TRP-group-level power restriction.

Aspect 16: An apparatus for wireless communication at a device, comprising a processor; memory coupled with the processor; and instructions stored in the memory and executable by the processor to cause the apparatus to perform the method of one or more of Aspects 1-8.

Aspect 17: A device for wireless communication, comprising a memory and one or more processors coupled to the memory, the one or more processors configured to perform the method of one or more of Aspects 1-8.

Aspect 18: An apparatus for wireless communication, comprising at least one means for performing the method of one or more of Aspects 1-8.

Aspect 19: A non-transitory computer-readable medium storing code for wireless communication, the code comprising instructions executable by a processor to perform the method of one or more of Aspects 1-8.

Aspect 20: A non-transitory computer-readable medium storing a set of instructions for wireless communication, the set of instructions comprising one or more instructions that, when executed by one or more processors of a device, cause the device to perform the method of one or more of Aspects 1-8.

Aspect 21: An apparatus for wireless communication at a device, comprising a processor; memory coupled with the processor; and instructions stored in the memory and executable by the processor to cause the apparatus to perform the method of one or more of Aspects 9-15.

Aspect 22: A device for wireless communication, comprising a memory and one or more processors coupled to the memory, the one or more processors configured to perform the method of one or more of Aspects 9-15.

Aspect 23: An apparatus for wireless communication, comprising at least one means for performing the method of one or more of Aspects 9-15.

Aspect 24: A non-transitory computer-readable medium storing code for wireless communication, the code comprising instructions executable by a processor to perform the method of one or more of Aspects 9-15.

Aspect 25: A non-transitory computer-readable medium storing a set of instructions for wireless communication, the set of instructions comprising one or more instructions that, when executed by one or more processors of a device, cause the device to perform the method of one or more of Aspects 9-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network node, a coherent joint transmission (CJT) configuration associated with a transmission reception point (TRP)-level power restriction;
transmit, to the network node, CJT channel state information (CSI); and
receive, from the network node and based at least in part on the CJT configuration and the CJT CSI, a subsequent downlink CJT that is subjected to the TRP-level power restriction.

2. The apparatus of claim 1, wherein the TRP-level power restriction is a common power restriction for a plurality of TRPs associated with the network node, and wherein the plurality of TRPs are associated with a same maximum transmission power in accordance with the common power restriction.

3. The apparatus of claim 1, wherein the TRP-level power restriction is a per-TRP power restriction for a plurality of TRPs associated with the network node, wherein a maximum transmission power is different among TRPs of the plurality of TRPs.

4. The apparatus of claim 1, wherein the TRP-level power restriction is a per-polarization power restriction, and wherein a same maximum transmission power is configured for either a first polarization or a second polarization of a certain TRP of a plurality of TRPs associated with the network node.

5. The apparatus of claim 1, wherein a transmission power associated with precoder coefficients indicated by the CJT CSI is associated with a per-TRP restriction.

6. The apparatus of claim 1, wherein a transmission power associated with precoder coefficients indicated by the CJT CSI is associated with a per-TRP restriction and a per-polarization restriction.

7. The apparatus of claim 1, wherein the TRP-level power restriction is a TRP-group-level power restriction, and wherein a group of TRPs from a plurality of TRPs associated with the network node are subjected to the TRP-group-level power restriction.

8. The apparatus of claim 1, wherein the CJT CSI is associated with a separate codebook for a plurality of TRPs associated with the network node, and wherein the CJT CSI indicates a co-amplitude, or the CJT CSI does not indicate the co-amplitude due to the plurality of TRPs being configured with the TRP-level power restriction.

9. An apparatus for wireless communication at a network node, comprising:
a memory; and
one or more processors, coupled to the memory, configured to:
transmit, to a user equipment (UE), a coherent joint transmission (CJT) configuration associated with a transmission reception point (TRP)-level power restriction;
receive, from the UE, CJT channel state information (CSI); and
transmit, to the ULE and based at least in part on the CJT configuration and the CJT CSI, a subsequent downlink CJT that is subjected to the TRP-level power restriction.

10. The apparatus of claim 9, wherein the TRP-level power restriction is a common power restriction for a plurality of TRPs associated with the network node, and wherein the plurality of TRPs are associated with a same maximum transmission power in accordance with the common power restriction.

11. The apparatus of claim 9, wherein the TRP-level power restriction is a per-TRP power restriction for a plurality of TRPs associated with the network node, wherein a maximum transmission power is different among TRPs of the plurality of TRPs.

12. The apparatus of claim 9, wherein the TRP-level power restriction is a per-polarization power restriction, and wherein a same maximum transmission power is configured for either a first polarization or a second polarization of a certain TRP of a plurality of TRPs associated with the network node.

13. The apparatus of claim 9, wherein a transmission power associated with precoder coefficients indicated by the CJT CSI is associated with a per-TRP restriction.

14. The apparatus of claim 9, wherein a transmission power associated with precoder coefficients indicated by the CJT CSI is associated with a per-TRP restriction and a per-polarization restriction.

15. The apparatus of claim 9, wherein the TRP-level power restriction is a TRP-group-level power restriction, and wherein a group of TRPs from a plurality of TRPs associated with the network node are subjected to the TRP-group-level power restriction.

16. A method of wireless communication performed by a user equipment (UE), comprising:
receiving, from a network node, a coherent joint transmission (CJT) configuration associated with a transmission reception point (TRP)-level power restriction;
transmitting, to the network node, CJT channel state information (CSI); and
receiving, from the network node and based at least in part on the CJT configuration and the CJT CSI, a subsequent downlink CJT that is subjected to the TRP-level power restriction.

17. The method of claim 16, wherein the TRP-level power restriction is a common power restriction for a plurality of TRPs associated with the network node, and wherein the plurality of TRPs are associated with a same maximum transmission power in accordance with the common power restriction.

18. The method of claim 16, wherein the TRP-level power restriction is a per-TRP power restriction for a plurality of TRPs associated with the network node, wherein a maximum transmission power is different among TRPs of the plurality of TRPs.

19. The method of claim 16, wherein the TRP-level power restriction is a per-polarization power restriction, and wherein a same maximum transmission power is configured for either a first polarization or a second polarization of a certain TRP of a plurality of TRPs associated with the network node.

20. The method of claim 16, wherein a transmission power associated with precoder coefficients indicated by the CJT CSI is associated with a per-TRP restriction.

21. The method of claim 16, wherein a transmission power associated with precoder coefficients indicated by the CJT CSI is associated with a per-TRP restriction and a per-polarization restriction.

22. The method of claim 16, wherein the TRP-level power restriction is a TRP-group-level power restriction, and wherein a group of TRPs from a plurality of TRPs associated with the network node are subjected to the TRP-group-level power restriction.

23. The method of claim 16, wherein the CJT CSI is associated with a separate codebook for a plurality of TRPs associated with the network node, and wherein the CJT CSI indicates a co-amplitude, or the CJT CSI does not indicate the co-amplitude due to the plurality of TRPs being configured with the TRP-level power restriction.

24. A method of wireless communication performed by a network node, comprising:
transmitting, to a user equipment (UE), a coherent joint transmission (CJT) configuration associated with a transmission reception point (TRP)-level power restriction;
receiving, from the UE, CJT channel state information (CSI); and
transmitting, to the UE and based at least in part on the CJT configuration and the CJT CSI, a subsequent downlink CJT that is subjected to the TRP-level power restriction.

25. The method of claim 24, wherein the TRP-level power restriction is a common power restriction for a plurality of TRPs associated with the network node, and wherein the plurality of TRPs are associated with a same maximum transmission power in accordance with the common power restriction.

26. The method of claim 24, wherein the TRP-level power restriction is a per-TRP power restriction for a plurality of TRPs associated with the network node, wherein a maximum transmission power is different among TRPs of the plurality of TRPs.

27. The method of claim 24, wherein the TRP-level power restriction is a per-polarization power restriction, and wherein a same maximum transmission power is configured for either a first polarization or a second polarization of a certain TRP of a plurality of TRPs associated with the network node.

28. The method of claim 24, wherein a transmission power associated with precoder coefficients indicated by the CJT CSI is associated with a per-TRP restriction.

29. The method of claim 24, wherein a transmission power associated with precoder coefficients indicated by the CJT CSI is associated with a per-TRP restriction and a per-polarization restriction.

30. The method of claim 24, wherein the TRP-level power restriction is a TRP-group-level power restriction, and wherein a group of TRPs from a plurality of TRPs associated with the network node are subjected to the TRP-group-level power restriction.
